(19) United States
(12) Patent Application Publication
(10) Pub. No.: US 2013/0230716 A1
(43) Pub. Date: Sep. 5, 2013

(54) PREPREGS BASED ON STORAGE-STABLE REACTIVE OR HIGHLY REACTIVE POLYURETHANE COMPOSITION WITH FIXED FILM AND THE COMPOSITE COMPONENT PRODUCED THEREFROM

(71) Applicants: Friedrich Georg Schmidt, Haltern am See (DE); Sandra Reemers, Muenster (DE); Arnim Kraatz, Darmstadt (DE)

(72) Inventors: Friedrich Georg Schmidt, Haltern am See (DE); Sandra Reemers, Muenster (DE); Arnim Kraatz, Darmstadt (DE)

(73) Assignee: EVONIK DEGUSSA GmbH, Essen (DE)

(21) Appl. No.: 13/824,035

(22) PCT Filed: Aug. 30, 2011
(86) PCT No.: PCT/EP2011/064905

§ 371 Date: May 22, 2013

(30) Foreign Application Priority Data
Sep. 23, 2010 (DE) 10 2010 041 256.2

(51) Int. Cl. B32B 27/12

(52) U.S. Cl. CPC B32B 27/12
USPC 428/339; 428/221; 156/307.1; 427/207.1

(57) ABSTRACT

The invention relates to prepregs based on storage-stable reactive or highly reactive polyurethane composition with fixed film and the composite component produced therefrom.

The invention relates to prepregs based on storage-stable reactive or highly reactive polyurethane composition with fixed film and the composite component produced therefrom.

### STATE OF THE ART

Many composite matrix materials are not weather-resistant or UV-resistant, or exhibit inadequate surface quality in combination with the glass or carbon fibre fabrics or nonwovens. Hence composite components are often coated subsequently, in order to achieve a special surface finish with regard to smoothness, colour, surface structure or other desired properties.

Composites (moulded parts) of fibre composite materials are coated for finishing or colouring of the surfaces. In most cases, the coating is effected by coating of the components, as is also done with a high degree of automation with SMC components in the production of vehicle body parts. Unfortunately, this is often associated with numerous defects (owing to the relatively high porosity of the composite components in comparison to injection-moulded parts) and rejection. By means of surface-sealing primers these problems can be at least partially eliminated, however these pretreatments are expensive and often associated with increased VOC (volatile organic compounds) emissions.

However, the coating process is very expensive since it is associated with high skilled labour costs.

In the article by Achim Grefenstein “Film insert moulding instead of coating”, in Metal Surface-Coating of Plastic and Metal, No. 10/99, Carl Hanser Verlag, Munchen, the use of films for surface finishing in injection moulding technology is described. The films are preformed and laid in an injection moulding appliance. The film is then insert moulded with plastic, and the desired surface of the composites is thus obtained.

DE 103 09 811 describes a process wherein a preformed film is laid in a mould, a fibre-reinforced prepreg, e.g. with a thermosetting or thermoplastic matrix, is applied with one onto the side of the preformed film, and after the curing and cooling of the plastic of the fibre-reinforced prepreg the finished composite is removed from the mould.

The fixing of a film on the surface of the composite can be effected by film insert pressing or film resin transfer moulding (film RTM). In this, a preformed film is applied onto one of the moulding tools of a press, the fibrous support in the form of a mat is laid on the counterpart of the tool of the press and the preformed film is bonded with the support with a pressing process appropriate for the composition of this semi-finished product.

The film resin transfer moulding (film RTM) is effected in a closed mould which is comparable to the closed press tools, female and male moulds, of a press. In the mould are laid the preformed film and a fibre mat, i.e. only the fibre reinforcement, beneath the cavity thereof. The evacuated mould is filled in known manner with a mixture of resin and curing agent, whereby the mat is impregnated and the cavity beneath the film completely filled. The mould remains closed until the injected resin has been cured. In open processes such as hand lamination or vacuum processes, this technique is also possible.

Such a process is for example known from EP 0 819 516.

Another process for surface finishing is a special form of the IMD process (in-mould decoration). In this, a printed support film is drawn over a moulding appliance. After the closure of the mould halves, the support film is moulded together with the decorative imprint by means of the pressure of an injected plastic. After curing of the plastic, and release of the component from the mould, the decorative impression adheres to the component produced, and the support film is then removed.

In EP 1 230 076, a process for application of a film by film moulding in the moulding appliance is described.

From EP2024164, a “one shot” process is known. In this, a mat-like semifinished product of binder-containing fibrous materials is heated strongly and then bonded with a decorative material (a lamination) and at the same time shaped in a press (and preferably in a so-called “cold press”).

From EP1669182, a process and a device for the production of compound moulded parts is known. In the production of single or multilayer films (skins) or compound moulded parts in which at least one layer consists of reactive plastic, this layer is applied by spraying into a cavity or onto a substrate.

Coating of the composite components with liquid gel coats already in the mould or the use of thermoplastic (multilayer) films by comoulding is also described [“In-Mold Decoration Dresses Up Composites”, Dale Brosius, Composites Technology, August 2005].

From EP 590 702, a fibre composite material is already known wherein a flexible film of a thermoplastic polymer is covered with a multifibre filament impregnated with a powder. The powder here has thermoplastic polymers as an essential component. As a result the fibre composite material should have high flexibility in particular for the formation of highly flexible mats. Storage-stable PUR compositions having uretdione groups are not mentioned.

However, all the aforesaid processes necessitate the application of the film onto the composite in a separate operation.

Prepregs based on a storage-stable reactive or highly reactive polyurethane composition are known from DE 102009001793, DE 102009001806 and DE 10201029355. However, these have no film coating.

The problem was to find novel prepregs with a finished surface and to simplify the production of prepregs and of composite components.

The problem is solved by storage-stable, polyurethane-based prepregs with a film intimately bonded on the surface of the prepregs, which for the required surface functionality is already fixed onto the surface in the production of the prepregs, wherein the film creates the required surface functionality of the composite component, and withstands the temperature conditions and pressure conditions during the composite component production.

It has been found that a simplification of the production of PU composite components which have a coloured, matt, especially smooth, scratch-resistant or antistatically treated surface can be effected through the prepregs according to the invention.

A subject of the invention are prepregs,

essentially made up of
A) at least one fibrous support
   and
B) at least one reactive or highly reactive polyurethane composition as matrix material, wherein the polyurethane compositions essentially contain mixtures of a polymer b) having functional groups reactive towards isocyanates as binder and di or polyisocyanate internally blocked and/or blocked with blocking agents as curing agent a), and
C) at least one film fixed onto the prepreg by the polyurethane composition B).

The production of the prepregs can in principle be effected by any process.

In a suitable manner, a powdery polyurethane composition is applied onto the support by powder impregnation, preferably by a dusting process. Also possible are fluidized bed sinter processes, pultrusion or spray processes. The powder (as a whole or a fraction) is preferably applied by dusting processes onto the fibrous support, e.g. onto ribbons of glass, carbon or aramid fibre nonwovens or fibre fabrics, and then fixed. For avoidance of powder losses, the powder-treated fibrous support is preferably heated in a heated section (e.g. with IR rays) directly after the dusting procedure, so that the particles are sintered on, during which temperatures of 80 to 100° C. should not be exceeded, in order to prevent initiation of reaction of the highly reactive matrix material. These prepregs can as required be combined into different forms and cut to size.

The production of the prepregs can also be effected by the direct melt impregnation process. The principle of the direct melt impregnation process for the prepregs consists in that firstly a reactive polyurethane composition B) is produced from the individual components thereof. This melt of the reactive polyurethane composition B) is then applied directly onto the fibrous support A), in other words an impregnation of the fibrous support A) with the melt from B) is effected. After this, the cooled storable prepregs can be further processed into composites at a later time. Through the direct melt impregnation process according to the invention, very good impregnation of the fibrous support takes place, due to the fact that the then liquid low viscosity reactive polyurethane compositions wet the fibres of the support very well.

The production of the prepregs can also be effected using a solvent. The principle of the process for the production of prepregs then consists in that firstly a solution of the reactive polyurethane composition B) is produced from the individual components thereof in a suitable common solvent. This solution of the reactive polyurethane composition B) is then applied directly onto the fibrous support A), whereby the fibrous support becomes soaked/impregnated with this solution. Next, the solvent is removed. Preferably the solvent is removed completely at low temperature, preferably <100° C., e.g. by heat treatment or application of a vacuum. After this, the storable prepregs again freed from the solvent can be further processed to composites at a later time. Through the process according to the invention, very good impregnation of the fibrous support takes place, due to the fact that the solutions of the reactive polyurethane compositions wet the fibres of the support very well.

As suitable solvents for the process according to the invention, all aprotic liquids can be used which are not reactive towards the reactive polyurethane compositions, exhibit adequate solvent power towards the individual components of the reactive polyurethane composition used and can be removed from the prepreg impregnated with the reactive polyurethane composition during the solvent removal process step apart from slight traces (<0.5 weight %), whereby recycling of the separated solvent is advantageous.

By way of example, ketones (acetone, methyl ethyl ketone, methyl isobutyl ketone, cyclo-hexanone), ethers (tetrahydrofuran), esters (n-propyl acetate, n-butyl acetate, isobutyl acetate, 1,2-propylene carbonate, propylene glycol methyl ether acetate) may be mentioned here. The prepregs according to the invention are preferably produced by this solvent process.

After cooling to room temperature, the prepregs according to the invention exhibit very high storage stability at room temperature, provided that the matrix material exhibits a Tg of at least 40° C. Depending on the reactive polyurethane composition contained this is at least a few days at room temperature, but as a rule the prepregs are storage-stable for several weeks at 40° C. and below. The prepregs thus produced are not sticky and are thus very good for handling and further processing. The reactive or highly reactive polyurethane compositions used according to the invention thus exhibit very good adhesion and distribution on the fibrous support.

During the further processing of the prepregs to composites (composite materials) e.g. by pressing at elevated temperatures, very good impregnation of the fibrous support takes place, due to the fact that the then liquid low viscosity reactive or highly reactive polyurethane compositions before the crosslinking reaction wet the fibres of the support very well, before gelling occurs or the complete polyurethane matrix cures fully due to the crosslinking reaction of the reactive or highly reactive polyurethane composition at elevated temperatures.

The prepregs thus produced can as required be combined into different forms and cut to size.

For the consolidation of the prepregs into a single composite and the crosslinking of the matrix material to give the matrix, the prepregs are cut to size, optionally sewn or otherwise fixed and compressed in a suitable mould under pressure and optionally application of vacuum. In the context of this invention, depending on the curing time this procedure of the production of the composites from the prepregs is effected at temperatures of over about 160° C. with the use of reactive matrix materials (modification I) or at temperatures of over 100° C. with highly reactive matrix materials provided with appropriate catalysts (modification II).

Depending on the composition of the reactive or highly reactive polyurethane composition used and optionally added catalysts, both the rate of the crosslinking reaction in the production of the composite components and also the properties of the matrix can be varied over wide ranges.

In the context of the invention, matrix material is defined as the reactive or highly reactive polyurethane composition used for the production of the prepregs and, in the description of the prepregs, the still reactive or highly reactive polyurethane composition applied on the fibre by the process according to the invention.

The matrix is defined as the matrix materials from the reactive or highly reactive polyurethane compositions crosslinked in the composite.

### Support

The fibrous support in the present invention consists of fibrous material (also often called reinforcing fibres). In general, any material of which the fibres consist is suitable, however, fibrous material of glass, carbon, plastics such as for example polyamide (aramid) or polyester, natural fibres or mineral fibre materials such as basalt fibres or ceramic fibres (oxide fibres based on aluminium oxides and/or silicon oxides) is preferably used. Mixtures of fibre types, such as for example fabric combinations of aramid and glass fibres, or carbon and glass fibres, can be used. Likewise, hybrid composite components with prepregs of different fibrous supports can be produced.

Mainly because of their relatively low price, glass fibres are the most commonly used fibre types. In principle here, all types of glass-based reinforcing fibres are suitable (E glass, S glass, R glass, M glass, C glass, ECR glass, D glass, AR glass, or hollow glass fibres). Carbon fibres are generally used in high performance composite materials, where the lower density in comparison to glass fibres with at the same time higher strength is also an important factor. Carbon fibres are industrially produced fibres made from carbon-containing starting materials which are converted by pyrolysis into carbon in graphite configuration. A distinction is made between isotropic and anisotropic: isotropic fibres have only low strength and lower industrial importance, anisotropic fibres exhibit high strength and rigidity with at the same time low elongation at break. Here all textile fibres and fibre materials obtained from plant and animal material (e.g. wood, cellulose, cotton, hemp, jute, flax, sisal or bamboo fibres) are described as natural fibres. Similarly also to carbon fibres, aramid fibres exhibit a negative coefficient of thermal expansion, i.e. become shorter on heating. Their specific strength and modulus of elasticity are markedly lower than that of carbon fibres. In combination with the positive coefficient of expansion of the matrix resin, highly dimensionally stable components can be manufactured. Compared to carbon fibre-reinforced plastics, the compressive strength of aramid fibre composite materials is markedly lower. Well-known brand names for aramid fibres are Nomex® and Kevlar® from DuPont, or Teijinconex®, Twaron® and Technora® from Teijin. Supports made of glass fibres, carbon fibres, aramid fibres or ceramic fibres are particularly suitable and preferred. The fibrous material is a flat textile sheet. Flat textile sheets of non-woven material, also so-called knitted goods, such as hosiery and knitted fabrics, but also non-knitted sheets such as woven fabrics, non-wovens or braided fabrics, are suitable. In addition, a distinction is made between long-fibre and short-fibre materials as supports. Also suitable according to the invention are rovings and yarns. All the said materials are suitable as fibrous supports in the context of the invention. An overview of reinforcing fibres is contained in “Composites Technologies, Paolo Ermanni (Version 4), Script for Lecture at ETH Zürich, August 2007, Chapter 7”.

### Matrix Material

Suitable matrix materials are in principle all reactive polyurethane compositions, and this includes other reactive polyurethane compositions that are storage-stable at room temperature. According to the invention, suitable polyurethane compositions consist of mixtures of a polymer b) (binder) having functional groups—reactive towards NCO groups, also described as resin, and di or polyisocyanates that are temporarily deactivated, in other words internally blocked and/or blocked with blocking agents, also described as curing agents a) (component a)).

As functional groups of the polymers b) (binder), hydroxyl groups, amino groups and thiol groups which react with the free isocyanate groups with addition and thus crosslink and cure the polyurethane composition are suitable. The binder components must be of a solid resin nature (glass transition temperature greater than room temperature). Possible binders are polyesters, polyethers, polyacrylates, polycarbonates and polyurethanes with an OH number of 20 to 500 mg KOH/gram and an average molecular weight of 250 to 6000 g/mole. Particularly preferably hydroxyl group-containing polyesters or polyacrylates with an OH number of 20 to 150 mg KOH/gram and an average molecular weight of 500 to 6000 g/mole are used. Of course, mixtures of such polymers can also be used. The quantity of the polymers b) having functional groups is selected such that for each functional group of the component b) 0.6 to 2 NCO equivalents or 0.3 to 1 uretdione group of the component a) is consumed.

As the curing component a), di and polyisocyanates that are blocked with blocking agents or internally blocked (uretdione) are used.

The di and polyisocyanates used according to the invention can consist of any aromatic, aliphatic, cycloaliphatic and/or (cyclo)aliphatic di and/or polyisocyanates.

As aromatic di or polyisocyanates, in principle, all known aromatic compounds are suitable. Particularly suitable are 1,3- and 1,4-phenylene diisocyanate, 1,5-naphthylene diisocyanate, tolidine diisocyanate, 2,6-toluoylene diisocyanate, 2,4-toluoylene diisocyanate (2,4-TDI), 2,4′-diphenylmethane diisocyanate (2,4′-MDI), 4,4′-diphenylmethane diisocyanate, the mixtures of monomeric diphenylmethane diisocyanates (MDI) and oligomeric diphenylmethane diisocyanates (polymeric MDI), xylylene diisocyanate, tetramethylxylylene diisocyanate and triisocyanatotoluene.

Suitable aliphatic di or polyisocyanates advantageously possess 3 to 16 carbon atoms, preferably 4 to 12 carbon atoms, in the linear or branched alkylene residue and suitable cycloaliphatic or (cyclo)aliphatic diisocyanates advantageously possess 4 to 18 carbon atoms, preferably 6 to 15 carbon atoms, in the cycloalkylene residue. (Cyclo)aliphatic diisocyanates are adequately understood by those skilled in the art simultaneously to mean cyclically and aliphatically bound NCO groups, as is for example the case with isophorone diisocyanate. In contrast, cycloaliphatic diisocyanates are understood to mean those which only have NCO groups directly bound to the cycloaliphatic ring, e.g. H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di and triisocyanate, undecane di and triisocyanate, and dodecane di and triisocyanate.

Isophorone diisocyanate (IPDI), hexamethylene diisocyanate (HDI), diisocyanatodicyclohexyl-methane (H₁₂MDI), 2-methylpentane diisocyanate (MPDI), 2,2,4-trimethylhexamethylene diisocyanate/2,4,4-trimethylhexamethylene diisocyanate (TMDI) and norbornane diisocyanate (NBDI) are preferred. Quite particularly preferably IPDI, HDI, TMDI and/or H₁₂MDI are used, and the isocyanurates are also usable. Also suitable are 4-methyl-cyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, 2,4′-methylenebis(cyclohexyl) diisocyanate and 1,4-diisocyanato-4-methylpentane.

Of course, mixtures of the di and polyisocyanates can also be used.

Further, oligo or polyisocyanates which can be produced from the said di or polyisocyanates or mixtures thereof by linking by means of urethane, allophanate, urea, biuret, uretdione, amine, isocyanurate, carbodiimide, uretonimine, oxadiazinetrione or iminooxadiazinedione structures are preferably used. Isocyanurate, in particular from IPDI and/or HDI, are particularly suitable.

The polyisocyanates used according to the invention are blocked. Possible for this are external blocking agents, such as for example ethyl acetoacetate, diisopropylamine, methyl ethyl ketoxime, diethyl malonate, ε-caprolactam, 1,2,4-triazole, phenol or substituted phenols and 3,5-dimethylpyrazole.

The curing agents preferably used are IPDI adducts which contain isocyanurate groups and ε-caprolactam-blocked isocyanate structures.

Internal blocking is also possible and this is preferably used. The internal blocking occurs via dimer formation via uretdione structures which at elevated temperature cleave back again to the isocyanate structures originally present and hence set the crosslinking with the binder in motion. Optionally, the reactive polyurethane compositions can contain additional catalysts. These are organometallic catalysts, such as for example dibutyl tin dilaurate (DBTL), tin octoate, bismuth neodecanoate, or else tertiary amines, such as for example 1,4-diazabicyclo[2.2.2]octane, in quantities of 0.001-1 wt. %. These reactive polyurethane compositions used according to the invention are cured under normal conditions, e.g. with DBTL catalysis, beyond 160° C., usually beyond ca. 180° C. and designated as modification I.

For the production of the reactive polyurethane compositions, the additives usual in powder coating technology, such as levelling agents, e.g. polysilicones or acrylates, light stabilizers e.g. sterically hindered amines, antioxidants or other additives, such as were for example described in EP 669 353, can be added in a total quantity of 0.05 to 5 wt. %. Fillers and pigments such as for example titanium dioxide can be added in a quantity up to 30 wt. % of the total composition.

In the context of this invention, reactive (modification I) means that the reactive polyurethane compositions used according to the invention as described above cure at temperatures beyond 160° C., depending on the nature of the support.

The reactive polyurethane compositions according to the invention are cured under normal conditions, e.g. with DBTL catalysis, beyond 160° C., usually beyond ca. 180° C. The time for the curing of the polyurethane composition used according to the invention as a rule lies within 5 to 60 minutes.

Preferably in the present invention a matrix material B) is used made of a polyurethane composition B) containing uretdione groups, essentially containing
a) at least one uretdione group-containing curing agent, based on polyaddition compounds from aliphatic, (cyclo)aliphatic or cycloaliphatic uretdione group-containing polyisocyanates and hydroxyl group-containing compounds, wherein the curing agent is in solid form below 40° C. and in liquid form above 125° C. and has a free NCO content of less than 5 wt. % and a uretdione content of 3-25 wt. %,
b) at least one hydroxyl group-containing polymer which is in solid form below 40° C. and in liquid form above 125° C. and has an OH number between 20 and 200 mg KOH/gram,
c) optionally at least one catalyst, and
d) optionally auxiliary agents and additives known from polyurethane chemistry,
   so that the two components a) and b) are present in the ratio such that for each hydroxyl group of the component b) 0.3 to 1 uretdione group of the component a) is consumed, preferably 0.45 to 0.55. The latter corresponds to a NCO/OH ratio of 0.9 to 1.1 to 1.

Uretdione group-containing polyisocyanates are well known and are for example described in U.S. Pat. No. 4,476,054, U.S. Pat. No. 4,912,210, U.S. Pat. No. 4,929,724 and EP 417 603. A comprehensive overview concerning industrially relevant processes for the dimerization of isocyanates to uretdiones is given in J. Prakt. Chem. 336 (1994) 185-200. In general, the conversion of isocyanates to uretdiones takes place in the presence of soluble dimerization catalysts such as for example dialkylaminopyridines, trialkylphosphines, phosphorous acid triamides or imidazoles. The reaction—optionally performed in solvents, but preferably in the absence of solvents—is stopped by addition of catalyst poisons on attainment of a desired conversion level. Excess monomeric isocyanate is then removed by short path evaporation. If the catalyst is sufficiently volatile, the reaction mixture can be freed from the catalyst in the course of the monomer removal. In this case the addition of catalyst poisons can be omitted. Essentially, a broad range of isocyanates are suitable for the production of uretdione group-containing polyisocyanates. The aforesaid di and polyisocyanates can be used. However, di and polyisocyanates from any aliphatic, cyclo-aliphatic and/or (cyclo)aliphatic di and/or polyisocyanates are preferable. According to the invention, isophorone diisocyanate (IPDI), hexamethylene diisocyanate (HDI), diisocyanato-dicyclohexylmethane (H₁₂MDI), 2-methylpentane diisocyanate (MPDI), 2,2,4-trimethyl-hexamethylene diisocyanate/2,4,4-trimethylhexamethylene diisocyanate (TMDI) or norbornane diisocyanate (NBDI) are used. Quite particularly preferably, IPDI, HDI, TMDI and/or H₁₂MDI are used, and the isocyanurates are also usable.

Quite particularly preferably, IPDI and/or HDI are used for the matrix material. The conversion of these uretdione group-containing polyisocyanates to uretdione group-containing curing agents a) comprises the reaction of the free NCO groups with hydroxyl group-containing monomers or polymers, such as for example polyesters, polythioethers, polyethers, polycaprolactams, polyepoxides, polyester amides, polyurethanes or low molecular weight di, tri and/or tetrahydric alcohols as chain extenders and optionally monoamines and/or monohydric alcohols as chain terminators and has already often been described (EP 669 353, EP 669 354, DE 30 30 572, EP 639 598 or EP 803 524).

Preferred curing agents a) having uretdione groups have a free NCO content of less than 5 wt. % and a content of uretdione groups of 3 to 25 wt. %, preferably 6 to 18 wt. % (calculated as C₂N₂O₂, molecular weight 84). Polyesters and monomeric dihydric alcohols are preferred. Apart from the uretdione groups, the curing agents can also have isocyanurate, biuret, allophanate, urethane and/or urea structures.

For the hydroxyl group-containing polymers b), polyesters, polyethers, polyacrylates, polyurethanes and/or polycarbonates with an OH number of 20-200 in mg KOH/gram are preferably used. Polyesters with an OH number of 30-150 and an average molecular weight of 500-6000 g/mole which are in solid form below 40° C. and in liquid form above 125° C. are particularly preferably used. Such binders have for example been described in EP 669 354 and EP 254 152. Of course, mixtures of such polymers can also be used. The quantity of the hydroxyl group-containing polymers b) is selected such that for each hydroxyl group of the component b) 0.3 to 1 uretdione group of the component a), preferably 0.45 to 0.55, is consumed. Optionally, additional catalysts c) can be contained in the reactive polyurethane compositions B) according to the invention. These are organometallic catalysts such as for example dibutyltin dilaurate, zinc octoate, bismuth neodecanoate, or else tertiary amines such as for example 1,4-diazabicyclo[2.2.2]octane, in quantities of 0.001-1 wt. %. These reactive polyurethane compositions used according to the invention are cured under normal conditions, e.g. with DBTL catalysis, beyond 160° C., usually beyond ca. 180° C. and designated as modification I.

For the production of the reactive polyurethane compositions according to the invention, the additives d) usual in powder coating technology, e.g. polysilicones or acrylates, light stabilizers e.g. sterically hindered amines, antioxidants or other additives, such as were for example described in EP 669 353, can be added in a total quantity of 0.05 to 5 wt. %. Fillers and pigments such as for example titanium dioxide can be added in a quantity up to 30 wt. % of the total composition.

The reactive polyurethane compositions used according to the invention are cured under normal conditions, e.g. with DBTL catalysis, beyond 160° C., usually beyond ca. 180° C. The reactive polyurethane compositions used according to the invention provide very good flow and hence good impregnation behaviour and in the cured state excellent chemicals resistance. In addition, with the use of aliphatic crosslinking agents (e.g. IPDI or H₁₂MDI) good weather resistance is also achieved.

Particularly preferably in the invention a matrix material is used which is made from
B) at least one highly reactive uretdione group-containing polyurethane composition, essentially containing
   a) at least one uretdione group-containing curing agent and
   b) optionally at least one polymer with functional groups reactive towards NCO groups;
   c) 0.1 to 5 wt. % of at least one catalyst selected from quaternary ammonium salts and/or quaternary phosphonium salts with halogens, hydroxides, alcoholates or organic or inorganic acid anions as counter-ion;
   and
   d) 0.1 to 5 wt. % of at least one cocatalyst, selected from
      d1) at least one epoxide
      and/or
      d2) at least one metal acetylacetonate and/or quaternary ammonium acetylacetonate and/or quaternary phosphonium acetylacetonate; and
   e) optionally auxiliary agents and additives known from polyurethane chemistry.

Quite especially, a matrix material B) made from
B) at least one highly reactive powdery uretdione group-containing polyurethane composition as matrix material, essentially containing
   a) at least one uretdione group-containing curing agent, based on polyaddition compounds from aliphatic, (cyclo)aliphatic or cycloaliphatic uretdione group-containing polyisocyanates and hydroxyl group-containing compounds, wherein the curing agent is in solid form below 40° C. and in liquid form above 125° C. and has a free NCO content of less than 5 wt. % and a uretdione content of 3-25 wt. %,
   b) at least one hydroxyl group-containing polymer which is in solid form below 40° C. and in liquid form above 125° C. and has an OH number between 20 and 200 mg KOH/gram;
   c) 0.1 to 5 wt. % of at least one catalyst selected from quaternary ammonium salts and/or quaternary phosphonium salts with halogens, hydroxides, alcoholates or organic or inorganic acid anions as counter-ion;
      and
   d) 0.1 to 5 wt. % of at least one cocatalyst, selected from
      d1) at least one epoxide
      and/or
      d2) at least one metal acetylacetonate and/or quaternary ammonium acetylacetonate and/or quaternary phosphonium acetylacetonate; and
   e) optionally auxiliary agents and additives known from polyurethane chemistry,
      is used so that the two components a) and b) are present in the ratio such that for each hydroxyl group of the component b) 0.3 to 1 uretdione group of the component a) is consumed, preferably 0.6 to 0.9. The latter corresponds to a NCO/OH ratio of 0.6 to 2 to 1 or 1.2 to 1.8 to 1 respectively. These highly reactive polyurethane compositions used according to the invention are cured at temperatures of 100 to 160° C. and designated as modification II.

Suitable highly reactive uretdione group-containing polyurethane compositions according to the invention contain mixtures of temporarily deactivated, that is uretdione group-containing (internally blocked) di or polyisocyanates, also described as curing agents a), and the catalysts c) and d) contained according to the invention and optionally in addition a polymer (binder) having functional groups—reactive towards NCO groups—also described as resin b). The catalysts ensure curing of the uretdione group-containing polyurethane compositions at low temperature. The uretdione group-containing polyurethane compositions are thus highly reactive.

Curing agents containing uretdione groups component a) and component b) used are those described above.

As catalysts under c), quaternary ammonium salts, preferably tetraalkylammonium salts and/or quaternary phosphonium salts with halogens, hydroxides, alcoholates or organic or inorganic acid anions as counter-ion, are used. Examples of these are:

Tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and tetrabutylammonium benzoate and tetrabutylphosphonium acetate, tetrabutylphosphonium formate and ethyltriphenylphosphonium acetate, tetrabutylphosphonium benzotriazolate, tetraphenylphosphonium phenolate and trihexyltetradecylphosphonium decanoate, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, tri-methylphenylammonium hydroxide, triethylmethylammonium hydroxide, tri-methylvinylammonium hydroxide, methyltributylammonium methanolate, methyltriethylammonium methanolate, tetramethylammonium methanolate, tetraethylammonium methanolate, tetrapropylammonium methanolate, tetrabutylammonium methanolate, tetrapentylammonium methanolate, tetrahexylammonium methanolate, tetraoctylammonium methanolate, tetradecylammonium methanolate, tetradecyltrihexylammonium methanolate, tetraoctadecylammonium methanolate, benzyltrimethylammonium methanolate, benzyltriethylammonium methanolate, trimethylphenylammonium methanolate, triethylmethylammonium methanolate, trimethylvinylammonium methanolate, methyltributylammonium ethanolate, methyltriethylammonium ethanolate, tetramethylammonium ethanolate, tetraethylammonium ethanolate, tetrapropylammonium ethanolate, tetrabutylammonium ethanolate, tetrapentylammonium ethanolate, tetrahexylammonium ethanolate, tetraoctylammonium methanolate, tetradecylammonium ethanolate, tetradecyltrihexylammonium ethanolate, tetraoctadecylammonium ethanolate, benzyltrimethylammonium ethanolate, benzyltriethylammonium ethanolate, trimethylphenylammonium ethanolate, triethylmethylammonium ethanolate, trimethylvinylammonium ethanolate, methyltributylammonium benzylate, methyltriethylammonium benzylate, tetramethylammonium benzylate, tetraethylammonium benzylate, tetrapropylammonium benzylate, tetrabutylammonium benzylate, tetrapentylammonium benzylate, tetrahexylammonium benzylate, tetraoctylammonium benzylate, tetradecylammonium benzylate, tetradecyltrihexylammonium benzylate, tetraoctadecylammonium benzylate, benzyltrimethylammonium benzylate, benzyltriethylammonium benzylate, trimethylphenylammonium benzylate, triethylmethylammonium benzylate, trimethylvinylammonium benzylate, tetramethylammonium fluoride, tetraethylammonium fluoride, tetrabutylammonium fluoride, tetraoctylammonium fluoride, benzyltrimethylammonium fluoride, tetrabutylphosphonium hydroxide, tetrabutylphosphonium fluoride, tetrabutylammonium chloride, tetrabutylammonium bromide, tetrabutylammonium iodide, tetraethylammonium chloride, tetraethylammonium bromide, tetraethylammonium iodide, tetramethylammonium chloride, tetramethylammonium bromide, tetramethylammonium iodide, benzyltrimethylammonium chloride, benzyltriethylammonium chloride, benzyltripropylammonium chloride, benzyltributylammonium chloride, methyltributylammonium chloride, methyltripropylammonium chloride, methyltriethylammonium chloride, methyltriphenylammonium chloride, phenyltrimethylammonium chloride, benzyltrimethylammonium bromide, benzyltriethylammonium bromide, benzyltripropylammonium bromide, benzyltributylammonium bromide, methyltributylammonium bromide, methyltripropylammonium bromide, methyltriethylammonium bromide, methyltriphenylammonium bromide, phenyltrimethylammonium bromide, benzyltrimethylammonium iodide, benzyltriethylammonium iodide, benzyltripropylammonium iodide, benzyltributylammonium iodide, methyltributylammonium iodide, methyltripropylammonium iodide, methyltriethylammonium iodide, methyltriphenylammonium iodide and phenyltrimethylammonium iodide, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride and benzyltrimethylammonium fluoride. These catalysts can be added alone or in mixtures. Tetraethylammonium benzoate and/or tetrabutylammonium hydroxide are preferably used.

The content of catalysts c) can be 0.1 to 5 wt. %, preferably from 0.3 to 2 wt. %, based on the total formulation of the matrix material.

One modification according to the invention also includes the binding of such catalysts c) to the functional groups of the polymers b). Apart from this, these catalysts can be surrounded by an inert shell and be enapsulated thereby.

As cocatalysts d1) epoxides are used. Possible here are for example glycidyl ethers and glycidyl esters, aliphatic epoxides, diglycidyl ethers based on bisphenol A and glycidyl methacrylates. Examples of such epoxides are triglycidyl isocyanurate (TGIC, trade name ARALDIT 810, Huntsman), mixtures of diglycidyl terephthalate and triglycidyl trimellitate (trade name ARALDIT PT 910 and 912, Huntsman), glycidyl esters of versatic acid (trade name KARDURA E10, Shell), 3,4-epoxycyclohexylmethyl 3′,4′-epoxycyclohexanecarboxylate (ECC), diglycidyl ethers based on bisphenol A (trade name EPIKOTE 828, Shell), ethylhexyl glycidyl ether, butyl glycidyl ether, pentaerythritol tetraglycidyl ether (trade name POLYPDX R16, UPPC AG) and other polypox types with free epoxy groups. Mixtures can also be used. Preferably ARALDIT PT 910 and 912 are used.

As cocatalysts d2), metal acetylacetonates are possible. Examples of these are zinc acetylacetonate, lithium acetylacetonate and tin acetylacetonate, alone or in mixtures. Zinc acetylacetonate is preferably used.

As cocatalysts d2), quaternary ammonium acetylacetonates or quaternary phosphonium acetylacetonates are also possible.

Examples of such catalysts are tetramethylammonium acetylacetonate, tetraethylammonium acetylacetonate, tetrapropylammonium acetylacetonate, tetrabutylammonium acetylacetonate, benzyltrimethylammonium acetylacetonate, benzyltriethylammonium acetylacetonate, tetramethylphosphonium acetylacetonate, tetraethylphosphonium acetylacetonate, tetrapropylphosphonium acetylacetonate, tetrabutylphosphonium acetylacetonate, benzyltrimethylphosphonium acetylacetonate and benzyltriethylphosphonium acetylacetonate. Particularly preferably, tetraethylammonium acetylacetonate and/or tetrabutylammonium acetylacetonate are used. Of course mixtures of such catalysts can also be used.

The quantity of cocatalysts d1) and/or d2) can be from 0.1 to 5 wt. %, preferably from 0.3 to 2 wt. %, based on the total formulation of the matrix material.

By means of the highly reactive and thus low temperature curing polyurethane compositions B) used according to the invention, at 100 to 160° C. curing temperature not only can energy and curing time be saved, but many temperature-sensitive supports can also be used.

In the context of this invention, highly reactive (modification II) means that the uretdione group-containing polyurethane compositions used according to the invention cure at temperatures from 100 to 160° C., depending on the nature of the support. This curing temperature is preferably 120 to 150° C., particularly preferably from 130 to 140° C. The time for the curing of the polyurethane composition used according to the invention lies within from 5 to 60 minutes.

The highly reactive uretdione group-containing polyurethane compositions used according to the invention provide very good flow and hence good impregnation behaviour and in the cured state excellent chemicals resistance. In addition, with the use of aliphatic crosslinking agents (e.g. IPDI or H₁₂MDI) good weather resistance is also achieved.

The production of the matrix material can be effected as follows: the homogenization of all components for the production of the polyurethane composition B) can be effected in suitable units, such as for example heatable stirred vessels, kneaders, or even extruders, during which temperature upper limits of 120 to 130° C. should not be exceeded. The mixing of the individual components is preferably effected in an extruder at temperatures which are above the melting ranges of the individual components, but below the temperature at which the crosslinking reaction starts. Use directly from the melt or after cooling and production of a powder is possible thereafter. The production of the polyurethane composition B) can also be effected in a solvent by mixing in the aforesaid units.

Next, depending on the process, the matrix material B) with the support A) and the film C) is processed into the prepregs.

The reactive or highly reactive polyurethane compositions used according to the invention as matrix material essentially consist of a mixture of a reactive resin and a curing agent. After melt homogenization, this mixture has a Tg of at least 40° C. and as a rule reacts only above 160° C. in the case of the reactive polyurethane compositions, or above 100° C. in the case of the highly reactive polyurethane compositions, to give a crosslinked polyurethane and thus forms the matrix of the composite. This means that the prepregs according to the invention after their production are made up of the support and the applied reactive polyurethane composition as matrix material, which is present in noncrosslinked but reactive form.

The prepregs are thus storage-stable, as a rule for several days and even weeks and can thus at any time be further processed into composites. This is the essential difference from the 2-component systems already described above, which are reactive and not storage-stable, since after application these immediately start to react and crosslink to give polyurethanes.

The prepregs according to the invention and also the composite components have a fibre content by volume of greater than 50%, preferably of greater than 50-70%, particularly preferably of 50 to 65%.

As (multilayer) films, laminated films based on thermoplastic plastics or mixtures thereof or compounds, e.g. from thermoplastic polyurethanes (TPU), thermoplastic polyolefins (TPO), (meth)acrylate polymers, polycarbonate films (e.g. Lexan SLX from Sabic Innovative Plastics), polyamides, polyether ester amides, polyether amides, polyvinylidene difluoride (e.g. SOLIANT FLUOREX films from SOLIANT, AkzoNobel or AVLOY from Avery) or metallized or metallic films such as for example aluminium, copper or other materials can be used, during which adhesion both to the still reactive or highly reactive uretdione group-containing matrix systems already takes place in the production of the prepregs. Apart from this, in addition a further fixing of the film takes place in the further processing of the prepregs to the cured polyurethane laminate surfaces of the composites. The laminated films based on thermoplastic materials can both be coloured as a whole by pigments and/or dyes and also printed or coated on the outer surface.

The laminated film has a thickness between 0.2 and 10 mm, preferably between 0.5 and 4 mm. The softening point lies between 80 and 260° C., preferably between 110 and 180° C., particularly preferably between 130 and 180° C. for the storage-stable highly reactive polyurethane compositions and between 130 and 220° C. for the reactive polyurethane compositions and particularly preferably between 160 and 220° C.

Suitable films are also for example described in WO 2004/067246.

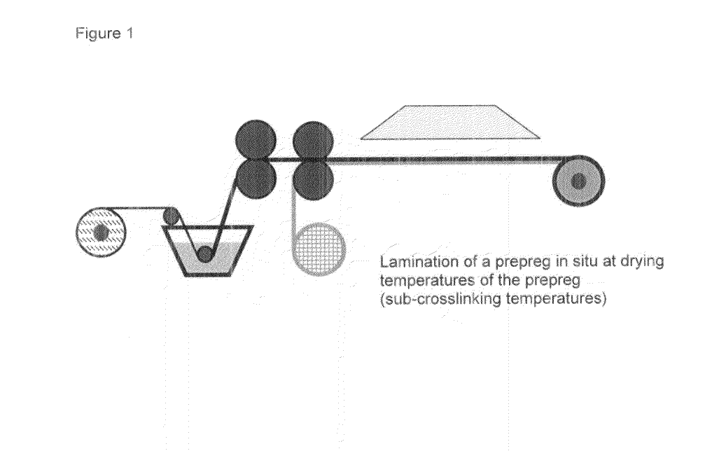

The fixing of the laminated film onto the prepreg takes place according to the invention directly in the production of the prepreg. Here the fixing of the film arises through the adhesion due to the matrix, shown by way of example in FIG. 1, by lamination of the prepreg in situ at drying temperatures of the prepreg (sub-crosslinking temperatures which designates the temperature at which the crosslinking of the matrix material does not yet begin). In general this fixing takes place at temperatures from 50 to 110° C.

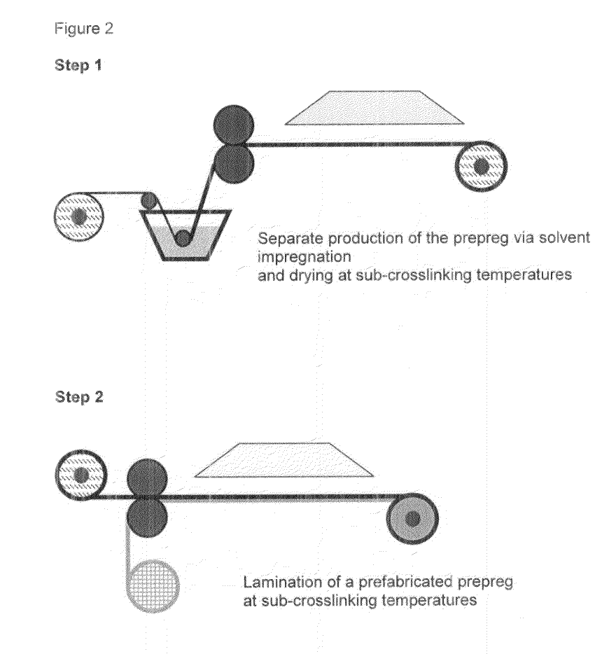

The fixing of the laminated film onto the prepreg can also take place such that in a first step a prepreg is produced and later in a second step the film is applied and fixed onto the already separately produced prepreg. Here the fixing of the film arises through the adhesion due to the matrix, shown by way of example in FIG. 2, by lamination of the prepreg at drying temperatures of the prepreg (sub-crosslinking temperatures). In general this fixing takes place at temperatures from 50 to 110° C.

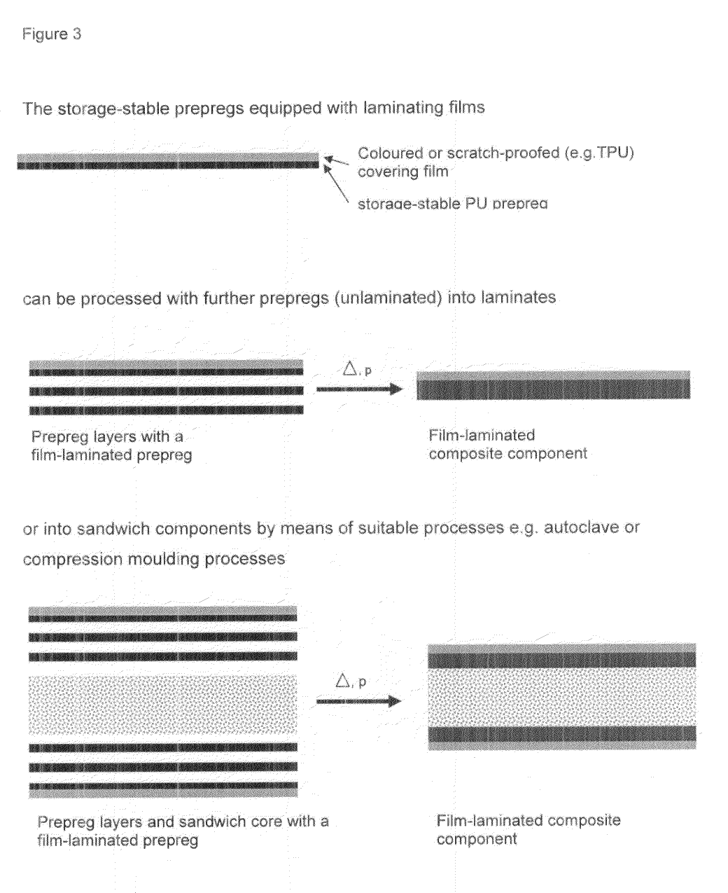

The storage-stable prepregs provided with laminated films thus produced can also be processed with further prepregs (unlaminated) into laminates or into sandwich components by suitable processes, e.g. autoclave or compression moulding processes, see FIG. 3.

An alternative to the use of a laminated film is the separate production of a decorative coating layer or film, from material that is the same or of similar formulation based on reactive or highly reactive polyurethane compositions B), with which the storage-stable prepregs according to the invention are produced.

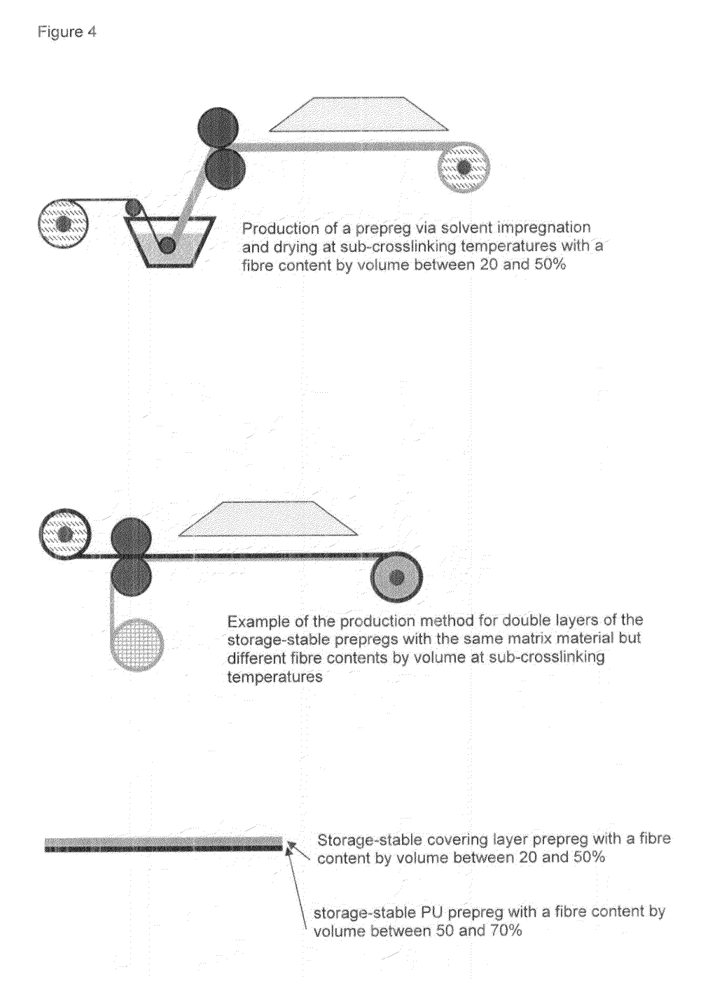

A further alternative (and embodiment of the invention) of a prepreg according to the invention has a special surface quality due to a markedly elevated matrix-to-fibre ratio. Accordingly, it has a very low fibre content by volume. For an especially smooth and/or coloured composite component surface, a fibre content by volume of <50%, preferably <40%, particularly preferably <35% is set in this embodiment. The production of a such prepreg is shown by way of example in FIG. 4.

The production of the laminated prepregs or the double layer prepregs according to the invention can be performed by means of the known plants and equipment by reaction injection moulding (RIM), reinforced reaction injection moulding (RRIM), pultrusion processes, by application of the solution in a cylinder mill or by means of a hot doctor knife, or other processes.

Also subject matter of the invention is the use of the prepregs, in particular with fibrous supports of glass, carbon or aramid fibres.

Also subject matter of the invention is the use of the prepregs produced according to the invention, for the production of composites in boat and shipbuilding, in aerospace technology, in automobile manufacture, and for two-wheel vehicles, preferably motorcycles and bicycles, and in the automotive, construction, medical engineering and sport fields, electrical and electronics industry, and power generating plants, e.g. for rotor blades in wind power plants.

Also subject matter of the invention are the composite components produced from the prepregs produced according to the invention. Depending on the nature of the film, the composite components produced from the prepregs according to the invention have a coloured, matt, especially smooth, scratch-resistant or antistatically treated surface.

### EXAMPLES

Glass fibre nonwovens and glass fibre fabrics used:

The following glass fibre nonwovens and glass fibre fabrics were used in the examples and are referred to below as type I and type II.

Type I is a linen E glass fabric 281 L Art. No. 3103 from “Schlösser & Cramer”. The fabric has an areal weight of 280 g/m².

Type II GBX 600 Art. No. 1023 is a sewn biaxial E glass nonwoven (−45/+45) from “Schlösser & Cramer”. This should be understood to mean two layers of fibre bundles which lie one over the other and are set at an angle of 90 degrees to one another. This structure is held together by other fibres, which do not however consist of glass. The surface of the glass fibres is treated with a standard size which is aminosilane-modified. The nonwoven has an areal weight of 600 g/m².

### Reactive Polyurethane Composition

A reactive polyurethane composition with the following formula was used for the production of the prepregs and the composites.

| | Formulation |
|---|---|
| | [Modification I] |
| | (according to invention) |
| Example I | in wt. % |
| VESTAGON BF 9030 | 26.8 |
| (uretdione group-containing curing agent | |
| component a)), Evonik Degussa | |
| FINEPLUS PE 8078 VKRK20 (OH-functional | 72.7 |
| polyester resin component b)), DIC Co. | |
| Flow additive BYK 361 N | 0.5 |
| NCO:OH ratio | 1:1 |

The milled ingredients from the table and the dyes and/or pigments are intimately mixed in a premixer and then homogenized in the extruder up to a maximum of 130° C. After this, this reactive polyurethane composition can be used for the production of the prepregs depending on the production process. This reactive polyurethane composition can then after milling be used for the production of the prepregs by the powder impregnation process. For the direct melt impregnation process, the homogenized melt mixture produced in the extruder can be used directly.

### Highly Reactive Polyurethane Composition

A highly reactive polyurethane composition with the following formula was used for the production of the prepregs and the composites.

| | Formulation |
|---|---|
| | [Modification II] |
| | (according to |
| | invention) |
| Example II | in wt. % |
| VESTAGON BF 9030 (uretdione group-containing | 33.05 |
| curing agent component a)), Evonik Degussa | |
| FINEPLUS PE 8078 VKRK20 (OH-functional | 63.13 |
| polyester resin component b)), DIC Co. | |
| BYK 361 N | 0.5 |
| Vestagon SC 5050, Tetraethylammonium | 1.52 |
| benzoate-containing catalyst c)), Evonik Degussa | |
| Araldit PT 912, (epoxy component d)), Huntsman | 1.80 |
| NCO:OH ratio | 1.4:1 |

The milled ingredients from the table and the dyes and/or pigments are intimately mixed in a premixer and then homogenized in the extruder up to a maximum of 110° C. This reactive polyurethane composition can then be used for the production of the prepregs depending on the production process.

### Production of the Prepregs

The production of the prepregs is effected by direct melt impregnation processes according to DE 102010029355.

The fixing of the films is effected directly following the melt impregnation of the fibrous supports, during which care is taken that on the prepreg the temperature of the impregnated matrix material existing during the fixing of the film lies between 5 and 20° C. above the glass transition temperature of the film, so that adhesion between film and prepreg takes place on application of pressure.

As films, for example FLUOREX 2010 (ABS support material) (Soliant) or SENOTOP films (Senoplast GmbH) are used. The Senotop film itself consists of several coextruded layers of thermoplastic material and is distinguished by a class A surface.

### DSC Measurements

The DSC tests (glass transition temperature determinations and enthalpy of reaction measurements) are performed with a Mettler Toledo DSC 821e as per DIN 53765.

### Storage Stability of the Prepregs

The storage stability of the prepregs was determined from the glass transition temperatures and the enthalpies of reaction of the crosslinking reaction by means of DSC studies.

The crosslinking capacity of the PU prepregs is not impaired by storage at room temperature for a period of 7 weeks.

| | |
|---|---|
| Time (days | |
| storage time) | Tg [° C.] |

| (FIG. 1) | Modification I | Modification II |
|---|---|---|
| 2 | 50 | 48 |
| 17 | 55 | 52 |
| 30 | 56 | 51 |
| 47 | 55 | 53 |

| | |
|---|---|
| Time (days | |
| storage time) | enthalpy of curing [J/g] |

| (FIG. 2) | Modification I | Modification II |
|---|---|---|
| 2 | 56 | 65 |
| 17 | 65 | 66.7 |
| 30 | 67 | 65.4 |
| 47 | 63 | 66.2 |

### Composite Component Production

The composite components are produced on a composite press by a compression technique known to those skilled in the art. The homogeneous prepregs produced by direct impregnation were compressed into composite materials on a benchtop press. This benchtop press is the Polystat 200 T from the firm Schwabenthan, with which the prepregs are compressed to the corresponding composite sheets at temperatures between 120 and 200° C. The pressure is varied between normal pressure and 450 bar. Dynamic compression, i.e. alternating applications of pressure, can prove advantageous for the crosslinking of the fibres depending on the component size, thickness and polyurethane composition and hence the viscosity setting at the processing temperature.

In one example, the temperature of the press is increased from 90° C. during the melting phase to 110° C., the pressure is increased to 440 bar after a melting phase of 3 minutes and then dynamically varied (7 times each of 1 minute duration) between 150 and 440 bar, during which the temperature is continuously increased to 140° C. Next the temperature is raised to 170° C. and at the same time the pressure is held at 350 bar until the removal of the composite component from the press after 30 minutes. The hard, rigid, chemicals resistant and impact resistant composite components (sheet products) with a fibre volume content of >50% are tested for the degree of curing (determination by DSC). The determination of the glass transition temperature of the cured matrix indicates the progress of the crosslinking at different curing temperatures. With the polyurethane composition used, the crosslinking is complete after ca. 25 minutes, and then an enthalpy of reaction for the crosslinking reaction is also no longer detectable. Two composite materials are produced under exactly identical conditions and their properties then determined and compared.

1. A prepreg article, comprising:
at least one prepreg comprising at least one fibrous support and at least one reactive or highly reactive polyurethane composition as matrix material; and
at least one film fixed onto the prepreg with the at least one reactive or highly reactive polyurethane composition,
wherein the at least one reactive or highly reactive polyurethane composition comprising at least one mixture of at least one polymer comprising at least one functional group reactive towards an isocyanate as binder and at least one di or polyisocyanate, and
the at least one di- or polyisocyanate is internally blocked, blocked, or both with at least one blocking agent as at least one curing agent and.

2. The prepreg article according to claim 1,
wherein the matrix material has a Tg of at least 40° C.

3. The prepreg article according to claim 1,
wherein the prepreg has a fibre content by volume of greater than 50%.

4. The prepreg article according to claim 1,
wherein the at least one film comprises:
at least one film or at least one multilayer film comprising a thermoplastic plastic, a mixture of the thermoplastic plastic or a compound or
at least one metalized or metallic film.

5. The prepreg article according to claim 1,
wherein the at least one film has a thickness between 0.2 and 10 mm.

6. The prepreg article according to claim 1,
wherein the at least one polymer has at least one selected from the group consisting of a hydroxyl group, an amino group, and a thiol group and
the at least one polymer has an OH number of from 20 to 500 mg KOH/gram and an average molecular weight of from 250 to 6000 g/mole.

7. A direct melt impregnation process for production of the prepreg article according to claim 1,
wherein a starting compound for the at least one di- or polyisocyante is isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethyl-hexamethylene diisocyanate (TMDI), norbornane diisocyanate (NBDI), an isocyanurate, or any combination thereof.

8. The prepreg article according to claim 1,
wherein the at least one blocking agent is an external blocking agent selected from the group consisting of ethyl acetoacetate, diisopropylamine, methyl ethyl ketoxime, diethyl malonate, ε-caprolactam, 1,2,4-triazole, phenol, a substituted phenol, and 3,5-dimethylpyrazole.

9. The prepreg article according to claim 1,
wherein the at least one di- or polyisocyanate is an IPDI adduct, an isocyanurate group, an ε-caprolactam blocked isocyanate structure, or any combination thereof.

10. The prepreg article according to claim 1,
wherein from 0.001 to 1 wt % of the at least one reactive or highly reactive polyurethane composition is at least one additional catalyst.

11. The prepreg article according to claim 1,
wherein the at least one reactive or highly reactive polyurethane composition comprising
at least one uretdione group-comprising curing agent comprising at least one polyaddition compound from an aliphatic polyisocyanate, a (cyclo)aliphatic polyisocyanate, a cycloaliphatic polyisocyanate, or a hydroxyl group-comprising compound, wherein the curing agent is in solid form below 40° C. and in liquid form above 125° C., and has a free NCO content of less than 5 wt. % and a uretdione content of from 3 to 25 wt. %,
at least one hydroxyl group-comprising polymer which is in solid form below 40° C. and in liquid form above 125° C. and has an OH number between 20 and 200 mg KOH/gram,
optionally at least one catalyst, and
optionally at least one auxiliary agent or additive,
and wherein, for each hydroxyl group of the at least one hydroxyl group-comprising polymer, 0.3 to 1 uretdione group of the at least one uretdione is consumed.

12. The prepreg article according to claim 1,
wherein a composition of the at least one reactive or highly reactive polyurethane composition is at least one highly reactive powdery uretdione group-comprising polyurethane composition, comprising
at least one uretdione group-comprising curing agent;
optionally at least one polymer with at least one functional group reactive towards an NCO group;
from 0.1 to 5 wt. % of at least one catalyst selected from the group consisting of a quaternary ammonium salt and a quaternary phosphonium salt with a halogen, a hydroxide, an alcoholate, or an organic or inorganic acid anion as counter-ion;
from 0.1 to 5 wt. % of at least one cocatalyst, selected from the group consisting of an epoxide a metal acetylacetonate, a quaternary ammonium acetylacetonate, and a quaternary phosphonium acetylacetonate; and
optionally at least one auxiliary agent or additive.

13. The prepreg article according to claim 1
wherein a composition of the at least one reactive or highly reactive polyurethane composition is at least one highly reactive powdery uretdione group-comprising polyurethane composition, comprising
at least one uretdione group-comprising curing agent comprising at least one polyaddition compound from an aliphatic polyisocyanate, a (cyclo)aliphatic polyisocyanate, a cycloaliphatic uretdione group-comprising polyisocyanate, or a hydroxyl group-comprising compound, wherein the curing agent is in solid form below 40° C. and in liquid form above 125° C. and has a free NCO content of less than 5 wt. % and a uretdione content of from 3 to 25 wt. %;
at least one hydroxyl group-comprising polymer which is in solid form below 40° C. and in liquid form above 125° C. and has an OH number between 20 and 200 mg KOH/gram;
from 0.1 to 5 wt. % of at least one catalyst selected from the group consisting of a quaternary ammonium salt and a quaternary phosphonium salt with a halogen, a hydroxide, an alcoholate, or an organic or inorganic acid anion as counter-ion;
from 0.1 to 5 wt. % of at least one cocatalyst selected from the group consisting of an epoxide a metal acetylacetonate, a quaternary ammonium acetylacetonate, and a quaternary phosphonium acetylacetonate; and
optionally at least one auxiliary agent or additive
and wherein, for each hydroxyl group of the at least one hydroxyl group-comprising polymer, 0.3 to 1 uretdione group of the at least one uretdione group-comprising curing agent is consumed.

14-15. (canceled)

16. A composite component obtained by a process comprising producing the composite component with the prepreg article of claim 1.

17. A process of producing a composite, the process comprising producing a composite with the prepreg article according to claim 1.

18. A process of producing a composite, the process comprising producing a composite with the prepreg article according to claim 1,
wherein the prepreg article is suitable for boat and ship building; aerospace technology; automobile manufacturing; two-wheel vehicle manufacturing; automotive, construction, medical technology, and sport fields; and electrical and electronics industry and power generation plants.

19. The prepreg article according to claim 1,
wherein the prepreg has a fibre content by volume of less than 50%.
